(19) United States
(12) Patent Application Publication
(10) Pub. No.: US 2025/0363505 A1
(43) Pub. Date: Nov. 27, 2025

(54) System and Method with Cryptography, Biometrics, and Artificial Intelligence for Verifying Consent to a Property Transaction

(71) Applicant: Roger Norris GORDON, Washington, DC (US)

(72) Inventor: Roger Norris GORDON, Washington, DC (US)

(21) Appl. No.: 19/298,089

(22) Filed: Aug. 12, 2025

Related U.S. Application Data
(63) Continuation-in-part of application No. 17/494,691, filed on Oct. 5, 2021.
Application No. 17/494,691 is a continuation-in-part of application No. 16/430,406, filed on Jun. 3, 2019, now abandoned.
(60) Provisional application No. 62/679,313, filed on Jun. 1, 2018.

(51) Int. Cl. G06Q 30/018; G06Q 50/16; G06V 40/12; G06V 40/16; G06V 40/70; G10L 17/10; H04L 9/08; H04L 9/32

(52) U.S. Cl. CPC G06Q 30/0185; G06Q 50/167; G06V 40/1365; G06V 40/172; G06V 40/70; G10L 17/10; H04L 9/088; H04L 9/3247

(57) ABSTRACT

A system and method are provided for implementing an autonomous, biometric and artificial intelligent transfer agent to prevent unauthorized or fraudulent real property transfers by verifying informed consent using multi-factor biometrics and cryptographically enforced compliance on a blockchain. In an exemplary embodiment, an automated enforcement agent captures a property owner's biometric identifiers to authenticate the owner's identity and uses artificial intelligence to detect signs of duress or anomaly in the transaction. Upon confirming the owner's consent and verifying the authenticity of the transaction, the automated enforcement agent generates a digitally signed certificate of compliance, which is then recorded on a blockchain distributed ledger in association with the property's title.

### CROSS-REFERENCE TO RELATED APPLICATIONS

This application is a Continuation-In-Part of U.S. patent application Ser. No. 17/494,691, filed Oct. 5, 2021, now pending, which is a Continuation-In-Part of U.S. patent application Ser. No. 16/430,406, filed Jun. 3, 2019, now pending, which claims benefit to U.S. Provisional Patent Application No. 62/679,313, filed Jun. 1, 2018, all of which are hereby incorporated by reference.

### BACKGROUND OF THE INVENTION

### Field of Invention

The present disclosure relates generally to a computerized system and method for verifying consent to a property transfer using cryptography.

### Description of the Prior Art

Financial exploitation of the elderly is a growing problem. Fraud targeting seniors' homes is particularly acute. They can lose their homes or home equity to bad actors if they sign contracts for sale, mortgage agreements, gift deeds, or other title-related contracts that are fraudulent or while they are under undue influence or experiencing diminished financial capacity. Collectively, these dangers are referred to herein as “Harm.” Numerous public agencies, consumer groups, and trade associations warn the problem will grow worse in the coming decades as America ages because many people experience failing eyesight, hearing, memory, and cognition as they grow older. Younger people also can experience physical and emotional hardships that make it harder for them to make good financial decisions.

The Securities and Exchange Commission advises seniors to consider sharing the details of their financial affairs with a trusted friend or relative who can raise a red flag if they suspect something is amiss. Unfortunately, many property owners do not know anyone who can take on this responsibility. However, even if they do know such a person, a friend or relative typically does not have the expertise, authority or legal standing (except for a spouse) and needs more to mount a challenge, especially if the bad actor is a relative or the victim's attorney. More fundamentally, many people do not want to share the details of their financial affairs with friends or relatives, even ones they trust.

A law professor has suggested that senior citizens could record covenants onto their homes' titles-so-called Elder HELP Instruments-expressly repudiating repugnant loan terms or excessive rates and fees. Even if it was possible to record a comprehensive list of predatory terms and keep it current, a question would remain as to whether a subsequently recorded agreement would be construed as superseding it. Also, the covenant could be revoked at the behest of a bad actor through undue influence or fraudulent inducement of the homeowner. A bad actor who obtained an interest in the property through any of these means could then sell its interest to a third party. This third party would be able to enforce its interest unless the defrauded homeowner could prove it acquired its interest in bad faith. Finally, there would be no way to remove the cloud on the title of a property protected by such an Elder HELP Instrument. Every subsequent interest holder, e.g., a purchaser or mortgagee, would have to determine whether its interest or any prior interest from which its interest was derived either violated or complied with the terms of the Elder HELP Instrument and its prohibition against “repugnant” or “excessive” terms, rates, and fees. Even if the subsequent interest holder believed it was in compliance, it would still be exposed to claims by the homeowner or its estate or heirs. Such exposure could negatively impact the marketability of subsequent interests in the property and likely also reduce its current value.

Until now, the most effective way property owners could protect themselves against Harm was to put their properties into irrevocable trusts managed by trustees. A trust is created when legal title to property is held by one person for the benefit of another. Although this is not the method of the present invention, the trust approach has several benefits, each of which the present invention shares, and several problems, each of which the present invention overcomes.

The first benefit of using an irrevocable trust managed by a third party is that the beneficiary of a trust is not completely isolated. This is because beneficiaries must interact with trustees. This reduces the effect of isolation and its role in enabling Harm. Second, when there is a competent third-party trustee, due diligence occurs regardless of the beneficiary's sophistication or mental state. Third, because the trustee appears on the title, the trustee is able to learn of and respond to fraudulent transactions directly and early on. In a legal challenge in which the authenticity of a signature or the knowledge and intent of the victim are at question, a trustee would likely enjoy greater credibility and be able to provide more persuasive evidence to a court than a private individual could, particularly one who was incapacitated or deceased.

The main problem with irrevocable trusts is that they require the homeowner to relinquish legal title to their property. If a property owner puts their property into a trust and then wants to sell, gift, or mortgage it, they must seek the trustee's permission. Many property owners are reluctant to put themselves in this position.

Another problem is expense. A senior who does not have a friend, relative, or acquaintance who is capable, willing, and trustworthy enough to be their trustee must hire a professional. Tax planning, compliance, audit, legal, and other overhead also add costs. Another cost driver is the requirement that a trustee always be available to conduct due diligence, authenticate transactions, defend the title, and respond to any future incapacity as well as to the eventual death of the beneficiary.

Finally, because a trustee holds legal title to a property and is only accountable to the beneficiary, any malfeasance or misfeasance on the trustee's part would be hard to detect if the beneficiary were to experience a decline in capacity, become isolated, or die. When the trustee is a lawyer, attorney-client privilege compounds the danger by shielding malfeasance from discovery.

Today, when defrauded property owners contest title transactions they usually allege fraud in the inducement, incapacity, duress, undue influence, unilateral mistake, unconscionability, forgery, or fraud in the execution. These claims can be difficult and expensive to prove, especially when the victim's memory, hearing, vision, judgment, awareness, or independence are at question or when the victim no longer has capacity or has died. More critically, only the last two claims—forgery and fraud in the execution—are grounds for rescinding fraudulent agreements after they have been sold by bad actors to third parties.

Forgery, i.e., creating a false document or signature, and fraud in the execution, i.e., hiding the true nature of an agreement, such as by secretly switching papers at the signing, are relatively rare and easier to prove than the other claims listed above. A stranger cannot steal a person's home simply by forging a signature on a deed and a bank cannot force a homeowner to repay a mortgage someone else obtained through fraud. Furthermore, unlike with other types of fraud, even if the perpetrators of forgery or fraud in the execution are successful, they cannot pass along good title to subsequent buyers. This is why many attorneys believe that services that are offered to protect homeowners against “title theft” by monitoring their titles in exchange for a monthly fee are not worth the money.

A much more common and far more successful species of fraud is “fraud in the inducement,” i.e., providing false or misleading information to a party to persuade them to sign an agreement. For example, a bad actor might tell a senior homeowner, falsely, that signing the house over to them is the only way to prevent the IRS from foreclosing on it. The senior knowingly signs over their home but only because they believe the falsehood that the IRS will otherwise take away their home. Not only is fraud in the inducement difficult to prove but, as discussed below, obtaining a remedy is often impossible.

Under the bona fide purchaser doctrine, a third party who purchases a property from a bad actor who obtained it from a victim through fraudulent means other than forgery or fraud in the execution is immune to a recovery action by the victim if the third party acquired its interest in good faith, i.e., without knowledge of the underlying fraud or of any other party's claim against the property. The bona fide purchaser can take good title to the property despite the claims of the defrauded original owner who may bring an action only against the party that transferred the property to the bona fide purchaser.

Under the holder in due course rule defined in the Uniform Commercial Code Section 3-302, a purchaser of a promissory note, mortgage, or other negotiable instrument may collect upon it over the objections of a defrauded obligor if the purchaser—the holder in due course—purchased the instrument in good faith and without notice that it had been dishonored or contained an unauthorized signature or had been altered or that any party had a defense or claim in recoupment. As in the case of a homeowner who is swindled by a bad actor who sells its property to a bona fide purchaser, a homeowner defrauded by a lender who sells the note to a holder in due course can only seek remedy against the bad actor. They must still pay the holder in due course.

Thus, although fraudulent inducement can be grounds for rescinding a contract, if the property or promissory note has been sold to a third party, to recover the property or prevent the enforcement of the note, the victim must prove that it was defrauded by the bad actor and that the third party knew or should have known about the underlying fraud. Because this is a very high hurdle to clear, in practice, a defrauded homeowner often can only seek damages from the person who defrauded them.

In this way, the bona fide purchaser doctrine and holder in due course rule allow bad actors to effectively launder ill-gotten titles and mortgages by selling them to third parties and then disappearing with the proceeds.

When a homeowner places its property into an irrevocable trust managed by a third party, fraud in the inducement is less likely to succeed because the trustee's due diligence is likely to detect it. Not only is a trust company more likely to have the resources to contest fraud in court but it also is likely to enjoy certain indicia of credibility, e.g., professional business practices and reputation, and to have a presence in the marketplace that would make it difficult for a fraudster to succeed. However, these features also increase the cost of trustee services and put them beyond the reach of most people.

To address these disadvantages, the present invention uses a legal covenant to “freeze” a home's title in a manner similar to freezing one's credit to prevent interests in the home from being created in third parties. The present invention employs a cryptographic technique to prevent the title from being unfrozen by anyone other than an enforcement agent charged with protecting the homeowner from Harm.

The present invention protects homeowners against Harm by solving at least three problems better than existing solutions do: (1) It provides homeowners with a trustworthy and affordable party who can maintain vigilance over their ability to make property-related decisions and to protect them if they become vulnerable or are victimized; (2) It prevents subsequent purchasers of any fraudulently obtained interests in their properties from raising bona fide purchaser or holder in due course defenses to their recovery efforts. (3) It allows legitimate future title holders to prove, from only the documents in the records, without contacting prior owners, that their title was obtained without Harm and that the requirements of the protective covenant were followed. The invention leverages technology to keep costs low and provide trustee-like services at an affordable price.

Although some embodiments present the case for combining cryptographic techniques with recorded covenants and notices to protect owners of real property, the method of the present invention may be applied to protect any property that exists in a jurisdiction or regime in which property ownership and interests are determined by reference to an authoritative record or ledger of property interests and transactions.

### SUMMARY OF THE INVENTION

The present invention may satisfy one or more of the above-mentioned desirable aspects. Other features and/or aspects may become apparent from the description which follows. The systems, methods and devices of the disclosure each have innovative aspects, no single one of which is indispensable or solely responsible for the desirable attributes disclosed herein. Without limiting the scope of the claims, some of the advantageous features will now be summarized.

In one aspect there is provided a computer-implemented method for maintaining a blockchain distributed ledger of transactions pertaining to the transfer of a property protected by the enforcement agent. The method includes: receiving, at a computing device, a request from a property owner to prepare a contract record for storing contract data regarding terms of the contract, wherein terms and conditions of the contract includes a protective scheme; such contracts are added to the blockchain by the enforcement agent either manually or by an automated process; contracts may include covenant records for recording covenant data regarding recordation of a covenants against the titles of the properties based on contracts, wherein each property covenant includes a public key and a protective covenant; creating a digital signature by signing the protective covenant with a cryptographic signature private key of the enforcement agent; future transaction activity related to property must then be also received and recorded to the blockchain; this will enable the enforcement agent to verify and authenticate a property transfer-related events according to terms of the contract's protective scheme stored earlier in the blockchain.

In another aspect, a non-transitory computer readable storage medium at a computing device running an enforcement agent and having connectivity to a network, wherein the non-transitory computer readable storage media are encoded with instructions that, when executed by a processor, cause the processor to perform a method for maintaining a blockchain distributed ledger of transactions pertaining to verifying consent of a transfer of a particular property. The method includes: receiving, at a computing device running an enforcement agent, a request from a property owner to prepare a contract record for storing contract data regarding terms of the contract in a blockchain; dynamic monitoring, by the enforcement agent of transaction activity related to a real property owned by the property owner to verify and authenticate a title-related event according to terms of the contract, wherein terms and conditions of the contract includes a protective scheme; generating, by the enforcement agent, a covenant record for recording covenant data regarding recordation of a covenant against the title of the real property based on the contract, wherein the covenant includes a public key and a protective covenant; creating a digital signature by signing the protective covenant with a cryptographic signature private key of the enforcement agent; and storing, by the enforcement agent, the data of the contract record and the covenant record in a repository in a blockchain distributed ledger having a plurality of transactions stored in the blockchain formed from blocks of records containing transactions.

Various embodiments provide robust identity verification that uses multi-modal biometrics, such as face, fingerprint, and voice, to verify the property owner's identity and intent. This feature makes impersonation or forgery extremely difficult or virtually impossible-only the true owner, confirmed through multiple independent biometric factors, can authorize a transfer. This ensures every transaction has genuine, verified consent from the rightful owner.

Various embodiments provide AI-driven fraud prevention that employs real-time anomaly detection AI to monitor transaction behavior and flag suspicious events before a title transfer is executed. The system automatically analyzes patterns (e.g. unusual transfer requests or timing) and issues instant alerts or blocks a transaction if the transactions is detected as being suspicious. This feature provides a proactive defense that adds an extra layer of security, preventing fraudulent or coerced transactions in advance rather than merely recording the transaction.

Various embodiments provide secure and transparent transactions. Approved transfers are recorded on a tamper-proof blockchain ledger, creating an immutable audit trail of ownership. In embodiments, the combination of biometric locks and blockchain immutability prevents unauthorized or fraudulent property transfers. Additionally, legitimate transactions can be completed remotely with confidence, since every step (from identity verification to final record) is secured and verifiable on the ledger in addition to being officially recorded on the government ledger.

In the following description, certain aspects and embodiments will become evident. It should be understood that the invention, in its broadest sense, could be practiced without having one or more features of these aspects and embodiments. It should also be understood that these aspects are merely exemplary and explanatory and are not restrictive of the invention.

### BRIEF DESCRIPTION OF THE DRAWINGS

FIGS. 1A-1B illustrate an exemplary computer-implemented method for verifying consent of a property transaction using cryptography.

FIG. 2 illustrates a computing system for verifying consent of a property transaction using cryptography in accordance with aspects of the present teachings.

FIG. 3 illustrates a computing system for verifying consent of a property transaction using cryptography and a trusted agent in accordance with aspects of the present teachings.

FIG. 4 illustrates another exemplary computer-implemented method for verifying consent of a property transaction using cryptography and a trusted agent.

The skilled artisan will understand that the drawings described below are for illustrative purposes only. The drawings are not intended to limit the scope of the present teachings in any way.

### DETAILED DESCRIPTION OF THE EMBODIMENT(S)

The present disclosure provides enhanced layers of security for confirmation of a validated transfer with informed consent to a property transaction. Certain aspects of the present disclosure relate to a computerized system and method for authenticating property transactions using cryptographically secured digital certificates. Some aspects of the present disclosure relate to verifying a property owner's informed consent to a property transaction based on a blockchain ledger and process for recording and verifying ownership of the digital certificates associated with the property transaction.

The systems and methods allow one or more processors to receive from a user, such as a property owner, a request for creating an electronic protective scheme that establishes certain conditions and procedures that future title-related agreements must comply with before they may become enforceable. The systems and methods then allows the user to enter into a contract with an enforcement agent to enforce the protective scheme. In some embodiments, the user and the enforcement agent may sign the contract using an electronic agreement or a smart contract system.

According to various embodiments, one or more steps described herein may be implemented by a human user, a non-human user, or through the interaction of a combination thereof. For example, the systems and methods may allow a human operator to define the terms of the contract agreement. Other embodiments may automate one or more steps in the process, for example, another computer program, software application, artificial intelligence (AI) or a machine learning algorithm may automatically perform one or more steps described herein.

In various embodiments, the human operator using the computer or the computer, autonomously or upon request, may function as the enforcement agent. The systems and methods then enable the enforcement agent to provide instructions to the one or more processors to create cryptographically signed covenants and digital certificates that authenticate ownership, monitor future transactions of the property, prevent transfer of the title, and/or authorize transfer of the title, as governed by the cryptographically signed covenants and digital certificates. The systems and methods may prevent transfers of or modifications to the title (i.e., they may “freeze” the title). When a transaction satisfies the requirements of the protective scheme, the systems and methods may authorize the transfer or modification of the title (i.e., “unfreeze” the title). Once the protective scheme has been satisfied, future owners and interest holders of the property may depend upon the cryptographically signed certificates to provide enforceable interests.

The term “transfer,” as used herein, refers not only to a change of ownership of a property but also to the creation of any interest in a property in any party other than its current owner. The term “transfer” may also include, for example, a security interest in a property created in a mortgagee by a mortgage agreement and a future interest created in a beneficiary by a property owner's will. The term “transfer” is used for the sake of brevity and should not be interpreted as limiting the application of the disclosed invention.

In the following detailed description, numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

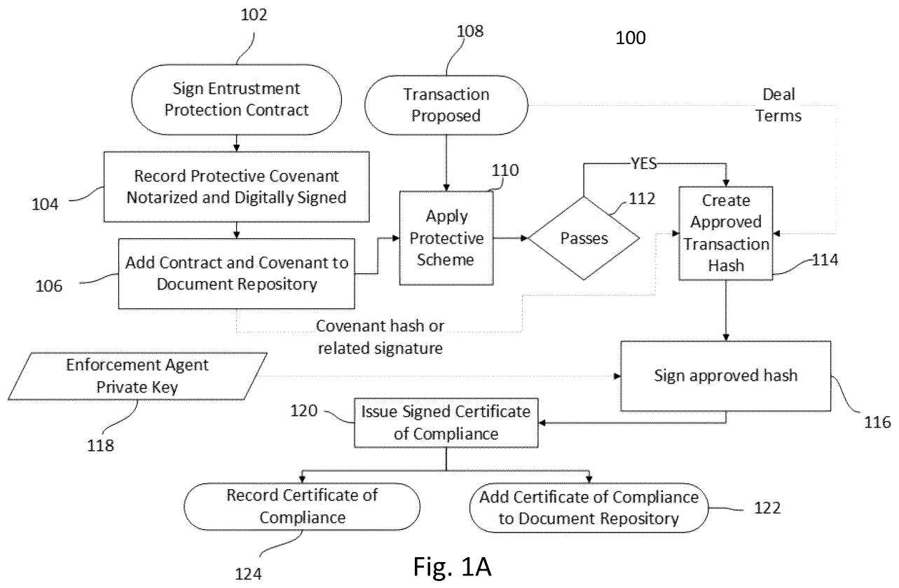

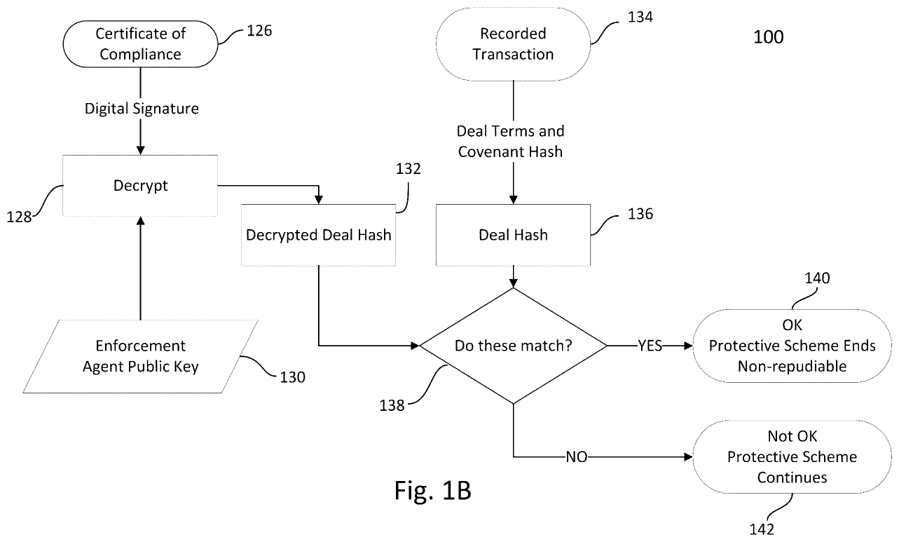

In one exemplary implementation, operation of the present invention may be consistent with the steps illustrated in the flowchart of FIGS. 1A-1B. It should, however, be understood that other alternative method steps may be employed and, even with the method depicted in FIGS. 1A-1B, the particular order of events may vary without departing from the scope of the present invention. Further, certain steps may not be present and additional steps may be added without departing from the scope and spirit of the invention as claimed.

FIGS. 1A-1B, as one example, illustrate a flow chart of a method 100 for generating digital certificates that are used to verify a property owner's informed consent to a property transaction. To implement the methods and systems, information, data, and/or programs can be stored in one or more databases. The method 100 allow one or more processors to receive from a user, such as a property owner, a request to create an electronic protective scheme that establishes certain conditions and procedures that future title-related agreements must comply with before they may become enforceable. In the description, the embodiments will be mainly described in terms of homeownership. However, it will be understood that other types of property ownership can be verified and monitored using the present invention. For example, the type of real property owned can be a residential, commercial, agricultural, industrial property, etc.

The protective scheme constraints entered into the computing system may define terms which should be met to effectuate transfer of the property. Namely, the protective scheme constraints protect against the unauthorized, deceptive or fraudulent transfer of the property. The protective scheme can require prospective buyers to enroll for verification. The protective scheme constraints may define terms that require prospective buyers, lenders, and giftees to provide identification information (including identifying the owners of any business entities they represent), to agree to background checks, and to make legally binding disclosures and affirmative representations upon enrollment into the computing system.

The method 100 may require the property owner to enter personal and relationship information that can be used to establish an alert or contact list. The property owner may designate friends, family members, legal representatives (i.e., an attorney, guardian, or trustee), or business contact in the alert-contact list. In some embodiments, the computing system may be programmed to autonomously conduct a search, such as on the Internet or an Intranet, to retrieve the personal and relationship information to build the user's alert-contact list.

Upon the request for a transfer of the property, the method may require that the computing system, using the alert-contact list, alert one or more designees listed in the contact list. The method may automatically alert, for example, the property owner's trusted friends, relatives and/or their financial advisor before the requested transfer or encumbrance is completed. The method may also require legal representation for the property owner under certain conditions. Legal representation may be required for the owner, for example, if the computing system or any person on the alert-contact list raises an issue of concern regarding the transaction. The method may also require the owner to be represented by legal counsel under certain other conditions, e.g., based on age, marital status (i.e., after the death of a spouse), or to conduct certain types of transactions, such as reverse mortgages.

The conditions defined in the protective scheme are designed to provide an automated process that prevents bad actors from fraudulently hiding behind business entities, prevents homeowners from entering into agreements while isolated, and to trigger and enforce due diligence regardless of the homeowner's state of mind or freedom to act. In this way, the present invention provides a function similar to that of a professional trustee but on an as-needed basis. The present invention provides an automated process that reduces cost and intrusiveness while providing robust protection against harmful property transfers.

In step 102 in FIG. 1A, the method 100 then allows the user, such as a homeowner, to enter into a contract with an enforcement agent to enforce the protective scheme that sets forth conditions precedent that future title transactions must meet. In some embodiments, the user and the enforcement agent may sign the contract using an electronic agreement or a smart contract system. Optionally, the method 100 may generate a smart contract that authenticates ownership of and/or tracks future transaction of the digital certificate. The method can store the smart contract in a smart contract database.

For instance, one such condition set forth in the contract may be that, by agreeing to the terms of the contract, the property owner acknowledges that no future agreement purporting to create an interest in the property in any third party will be valid unless the agreement bears a certificate of compliance signed by the enforcement agent. The method may automatically generate and issue an electronic certificate of compliance for the agreement. As part of its execution, the method produces an electronic certificate of compliance, which attests that the proffered agreement and the parties to it have complied with the terms of the protective scheme. This type of contract may be referred to as an entrustment protection contract and is enforceable by the party that provides the service even though it receives, rather than pays, consideration. The certificate of compliance may be stored by the system and method in a database, and the system may communicate the compliance, as needed.

As terms of the electronic contract, the system and method 100 automatically creates a property interest in the enforcement agent and records the property interest. The contract creates a property interest in the enforcement agent that may have, for example, the following three effects.

First, the method and system automatically establish the enforcement agent as a senior lienholder with respect to subsequent lienholders. A senior lienholder is a lienholder that has priority over another lienholder. If the property is or becomes subject to more than one lien, priority determines the lienholder's right. The method and system automatically records the property interest of the enforcement agent as a lien in the land records to provide a higher priority than later recorded liens. As a senior lienholder the enforcement agent is empowered to prevent future claims from being enforced if they are created through transactions that do not comply with the terms of the protective scheme the enforcement agent is contracted to enforce.

Second, the method and system may be programmed to stipulate the terms and circumstances under which the contract can or cannot be terminated. The terms of the contract may prevent the property owner from unilaterally terminating, revoking, or rescinding the contract. Mutual agreement between the property owner and the enforcement agent may be required to terminate, revoke or rescind the contract. This constraint prevents the property owner from dismantling the protective scheme if the property owner later becomes subject to undue influence or diminished financial capacity.

Third, the terms defined by the method and system give the enforcement agent standing to sue. Implementation of the method 100 provides standing to sue because the enforcement agent has a legally protectable and tangible interest in the property. Thus, the enforcement agent will be a proper party to fight any adverse action taken against the property. This gives the enforcement agent independent standing to pursue claims and remedies against bad actors. In comparison, the present invention is superior to a conventional trust approach because it allows a bad actor to be pursued by both the homeowner and the enforcement agent for independent claims. Trustees, on the other hand, can pursue claims only on behalf of the trust or, derivatively, on their own behalf as trustees of the trust.

In step 104 in FIG. 1A, the enforcement agent records and stores in a database a protective covenant against the title to the home and signs it with a private key. The covenant includes the enforcement agent's public key and states that any future certificates of compliance must be signed with the enforcement agent's private key.

The enforcement agent records its interest (sometimes referred to as a “negative easement”) in the form of a protective covenant against the title to the property. This recordation gives prospective interest holders constructive notice of the enforcement agent's presence as a senior lienholder, of the protective scheme, of the entrustment protection contract, and of the certification requirement. Once the protective covenant has been recorded, no interest can be created in any third party through a transaction agreement that is not accompanied by a certificate of compliance signed by the enforcement agent. In some embodiments, the enforcement agent is an automated agent that runs on a computing device. In other embodiments, the enforcement agent steps are manually performed by a user. For example, in the automated embodiments, the enforcement agent electronically records the interest in a database of the system.

Continuing with reference to step 104, the method 100 then enables the enforcement agent to provide instructions to the one or more processors to create cryptographically signed covenants and digital certificates that authenticate ownership, monitor future transactions of the property, prevent transfer of the title, and authorize transfer of the title, as governed by the cryptographically signed covenants and digital certificates.

The recorded protective covenant states that any subsequent Certificates of Compliance must be signed with the enforcement agent's cryptographic signature, which is generated using its private key through usage of a public-private key cryptography. Public-key cryptography uses a pair of mathematically related cryptographic keys, referred to as the “private key” (or “secret key”) and the “public key.” The private key is intended to be associated uniquely with one user and kept secret. The public key may be freely distributed and known to anyone.

Public-key cryptography, according to the present invention, can be used to provide confidentiality, verification, authenticity, and non-repudiation. The public-key encryption may be used to send information confidentially. For example, a sender may encrypt a message with the recipient's public key, which can only be decrypted by the recipient's paired private key.

Another application of the public-key cryptography according to the present invention is verification and authentication using digital certificates and digital signatures. Herein, the term “digital certificates” refer to a signed electronic document that notarizes and binds the connection between a public key and its legitimate owner to prove the owner's identity. Its purpose is to prevent unauthorized impersonation and provide confidence in the public keys. The term “digital signature” refers to an electronic identification of a person or thing created by using a public-key algorithm, intended to verify to a recipient the integrity of the data and the identity of the sender of the data.

Further application of the public-key cryptography according to the present invention is non-repudiation that uses digital signature to ensure that one party cannot successfully dispute authorship of a document or communication. Namely, the recipient of a communication or data has assurance that the sender in fact sent the communication or data even though the sender later may want to deny ever having sent the communication or data.

According to the present invention, users, such as the enforcement agent, can generate the digital certificate themselves. However, in some embodiments, a public-key infrastructure (PKI) using a certificate authority (CA) may be employed to issue the digital certificate. The PKI is a security architecture that increases the level of security and confidence for exchanging information electronically over a network. PKIs can be used to authenticate the sender or recipient of electronic information and/or authenticate that the content of an electronic document or message has not been deliberately altered or otherwise modified.

Generally known, a CA is a trusted individual or organization (public or private) that issues, manages and revokes digital certificates, validating that public keys are not compromised and that they belong to the correct owners. The CA may generate the public/private key pair in the digital certificate or sign the public key of a requester (after the CA verifies the identity of the requester). The CA verifies the credentials provided by the certificate requester and, upon confirming the requester's identity, digitally signs the digital certificate with the CA's private key.

Applied Cryptography, Second Edition: Protocols, Algorithms, and Source Code in C, by Bruce Schneier, published by John Wiley & Sons, Inc. in 1996, and ICSA Guide to Cryptography, by Randall K. Nichols, published by McGraw-Hill in 1999, which are incorporated by reference herein, provide additional information on the use and implementation of public-key cryptography, digital signatures and digital certificates.

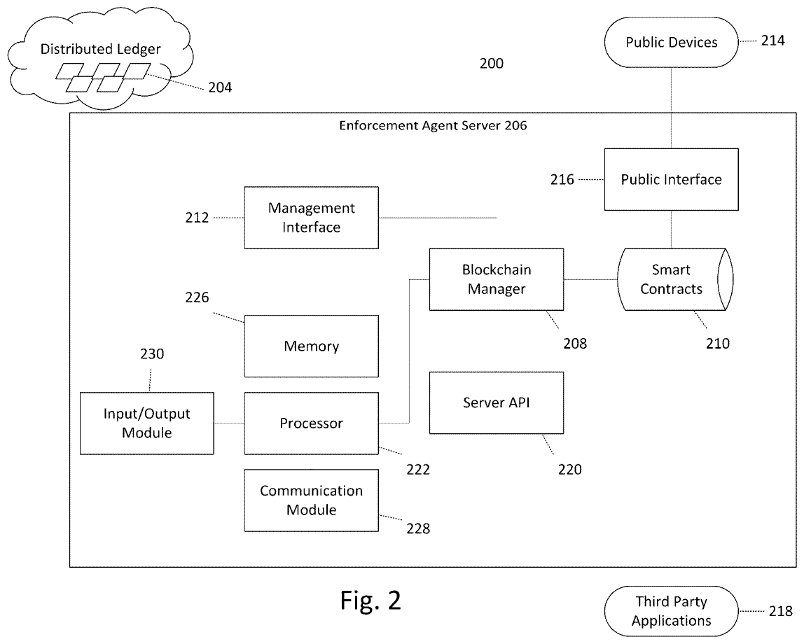

In embodiments consistent with the present invention in FIG. 2, the system 200 can include one or more input devices. The input device may be any device capable of receiving information and converting it to digital information for use by the system. The input device may be, for example, a keyboard or keypad, card reader, USB device, fingerprint or other biometric reader, camera, scanner, CD/DVD reader, handset or handheld device, personal digital assistant (PDA), wireless interface, personal computer, and/or Internet connection. The input device may be used, for example, to read digital certificate information from a smart card, magnetic strip card, or printed document. Input device may also be used, for example, to receive user identification information such as PINs, passwords, fingerprints, retinal patterns, or other biometric information. One or more connections may be provided from the input device to the system 200 through which digital data may be passed, such as a bus or a wireless connection, among others.

Thus, digital certificates and digital certificate information may be input into the system 200 in any of a number of ways known to those skilled in the art. For example, digital certificates may be stored on a physical medium, such as paper, card, or chip, and the digital certificate information stored on the physical medium may be input into system 200 by, for example, reading the information from the physical medium by using an input device, such as a scanner, card reader, or other input device. The input device may be separate from system 200 and capable of providing data electronically to system 200, either via physical connection or wirelessly. In certain embodiments, digital certificates and digital certificate information may be input into the system 200 from, for example, another device or computer across the Internet or other network connection. In other embodiments, digital certificate information is entered into system 200 by, for example, using a keyboard, mouse, user interface, or other conventional input device.

In certain embodiments, all digital certificate information is received or available locally and all authentication operations may be performed at system 200 without needing Internet or network connections.

The digital certificates may include digital certification information, such as the name of the certificate owner, a public key associated with the certificate owner, dates of validity of the certificate, the name of the CA that issued the digital certificate, the actions for which the keys may be used, and the method the CA used to sign the digital certificate (e.g., RSA).

In step 104, a digital protective covenant is generated such that the digital protective covenant verifies the receipt of the digital record of the digital information, such as the contract. A digital signature is applied to the digital protective covenant. As described above, the digital signature may be any type of signature that authenticates the identity of the owner of the repository. For example, the digital signature may be based on a private/public key encryption scheme, such as RSA. In a preferred embodiment, the certificate is digitally signed using a private key, for example, of the enforcement agent.

In step 106, the new digital record or a representation of the contract and covenant is added to a repository, such as a federated blockchain repository. The blockchain is a shared, immutable ledger that facilitates the process of recording transactions and tracking assets in a network. Virtually, any intangible or tangible asset of value can be tracked and transferred on the blockchain network reducing risk and cutting costs for all involved. According to the present invention, utilizing the blockchain technology, both intangible assets, such as the contract and covenant, and tangible assets, such as the real property including land and buildings, can be tracked, validated, and transferred.

As shown in FIG. 2, computing system 200 operates as blockchain platform in which asset transaction records-known as “blocks”—are linked via cryptographic hash functions in a distributed, immutable ledger of interconnected blocks. Each block in the chain includes one or more digital asset transactions accompanied by corroboration information representing a validity of each transaction. The architecture of the computing system 200 allows for identity verification and authentication of transacted assets while preventing duplication of a cryptography-protected (“cryptographic”) digital asset registered to the platform.

The blockchain may include a growing list of records in the form of data blocks. Each block is linked to a previous block immediately before it in the blockchain by including the cryptographic hash of the previous block. Each block may include a timestamp, a cryptographic hash of a previous block, and data of the present block, which may be one or more transactions related to the intangible asset or tangible asset of the real property.

After the records have been received and registered in the blockchain in step 106, in one aspect, the system 200 may use the record to record proof of ownership or purchase of an asset, such as a transfer of the real property between one participant and the next. The transfer of the real property may be stipulated according to the terms of the protective covenant of the contract, such as a smart contract. Thus, the blockchain may operate according to terms of the smart contract to facilitate, verify, or enforce the negotiation or performance of the contract. The user, such as the enforcement agent, may program agreed terms into the smart contract and the smart contract may be automatically executed by the blockchain system to perform a transaction. The smart contract may be operational codes that are fully or partially executed without human interaction.

According to the present invention, one of the agreed upon terms of the recorded protective covenant as programmed in the smart contract may state that any subsequent certificates of compliance must be signed by the enforcement agent's cryptographic signature, which is generated using its private key in a public-private key infrastructure. To prevent an authentic cryptographic signature from being copied onto and used to fraudulently authenticate an unauthorized document, for example, that may attempt to transfer or place a lien on the property, the present system 200 employs two independent methods that can be implement according to the system 200 and the process 100 in FIGS. 1A-1B.

In the first method, the enforcement agent creates a cryptographic hash of key terms from the approved agreement and the recorded covenant using a secure hash algorithm such as SHA1. The enforcement agent then signs the hash with its cryptographic signature using its private key.

When the signature is authenticated using the enforcement agent's public key, the hash is decrypted. To verify that the terms in the as-yet unauthenticated document are the same terms that were in the certified agreement, the selected terms of the unauthenticated agreement, and any additional terms from the recorded covenant that were used for the signed hash's inputs, are used to create a new hash. If this hash matches the decrypted signed-hash of the terms of the authenticated agreement, then the certificate is valid.

This method can be applied to paper documents using image capture and Optical Character Recognition (OCR) or other digital representations of the key terms—for example, but not limited to, QR codes—that can represent the hashes or the inputs to be hashed and subsequently compared to the decrypted signed-hash. See, for example, A Model for Embedding and Authorizing Digital Signatures in Printed Documents, by Lee, Kwon, et al in Korea Information Security Agency, ICISC (2002), which is incorporated herein by reference.

In an alternative method, the enforcement agent places cryptographically-signed copies of the transaction documents—or of their hashes or both—into a federated blockchain repository that any authorized party can examine. Cryptographically signed documents in such a storage system are extremely difficult to alter and cannot be disavowed by the party that signed them. This reduces the risk that a stolen private key poses. An authorized party can compare the document in the repository with the one in its possession to determine whether the latter document is authentic. After the records have been received and registered in step 106, the method provides a way to verify the order in which particular records were registered. One exemplary way according to the present invention to confirm the history of recordation is to include a cryptographic digest of all previously registered records in the digital certificate issued by applying a cryptographic hash function. Cryptographic digests, which incorporate older certificates, create causal, one-way relationships between the confirmations and thus can be used to verify their order without fear of erroneous behavior, because any erroneous confirmation is detectable by a verifier examining the one-way causal hash chain.

By employing a cryptographic signature that must be authenticated before it may be relied upon, the present invention prevents a subsequent third-party purchaser of an interest that was obtained from a homeowner without the enforcement agent's involvement from claiming to be a bona fide purchaser or a holder in due course. A bona fide purchaser is a party that pays valuable consideration for a property, has no notice of any outstanding claims of other parties and acts in good faith. A holder in due course is one who takes a negotiable instrument, such as check or promissory note, for value, in good faith, and without notice of any claim or defense against it or without notice that the instrument contains an unauthorized signature or has been altered. Bona fide purchasers and holders in due course can enforce their interests free from all claims and personal defenses that previous owners and interest holders might have against the parties that sold them their interests. According to the present invention, purchasers or holders can claim such protection only if they possess authenticated certificates of compliance for the transactions through which they allegedly obtained their claimed interests. This is because such a party cannot claim not to have notice of the requirement of a digitally signed certificate of compliance and because a digital signature must be authenticated before it may be relied upon. The subsequent purchaser would either lack a certificate of compliance entirely or, having attempted to authenticate the digital signature, would know that it was a forgery.

Because prospective interest holders have constructive notice of the recorded protective covenant, and because a cryptographic signature must be authenticated before it may be relied upon and cannot be forged, it is not possible for a purchaser to rely upon an inauthentic signature in good faith. In addition to protecting homeowners against forgery, by using cryptographic signatures to freeze and unfreeze titles, the present invention also protect homeowners against fraud in the inducement, undue influence, and other forms of Harm.

The protective scheme enforced by the enforcement agent is designed to protect property owners from falling victim to Harm, including that caused by inexperience or diminished financial capacity. If a party were to attempt to enforce a claimed interest obtained without the enforcement agent's involvement, such as by obtaining an order of eviction, or to transfer it to a third party, by presenting a cryptographic signature on a certificate of compliance as proof of the legitimacy of its interest, the party would be guilty of forgery. Forgery is not only grounds for recission but also a crime.

Second, even without a court's involvement, our invention makes it difficult for bad actors to sell their claimed interests to third parties. This is because the recorded protective covenant puts third parties on notice that if they purchase a property or promissory note that is protected by a covenant but not accompanied by a certificate of compliance bearing an authentic cryptographic digital signature, they cannot claim to be good faith purchasers or holders in due course. This is because it is impossible to forge a cryptographic signature and just as impossible to knowingly accept a forged signature in good faith.

Because a cryptographic signature cannot be repudiated, if the protective scheme were to fail and fraud (other than forgery or fraud in the execution) were to be discovered after a transaction was certified, then a third-party buyer or lender in possession of a certificate of compliance signed by the enforcement agent would still have an enforceable agreement. This is because, although the underlying transaction may have been fraudulent, the third party could establish that it obtained its interest in good faith and in compliance with the terms of the covenant and without notice of any underlying fraud or claim. The cryptographically signed certificate of compliance would function as an estoppel certificate, i.e., a written, signed stipulation of established facts that prevents the author from subsequently contradicting or recanting those facts. The certificate would prevent both the victim and the enforcement agent from making covenant-related claims against the third party. Thus, our system preserves the marketability of interests conveyed in compliance with the protective scheme.

In conclusion, in embodiments where the system and method provide an additional layer of security, authentication, and verification of an asset as defined by the terms of the covenant, the present invention offers property owners the advantages of the trust and “tell a friend” approaches—prevention of isolation, ability to enforce due diligence, standing to pursue remedies, fiduciary duty, availability, and personal knowledge of the owner—but without their disadvantages: loss of control, costliness, lack of accountability, personal burden, and invasion of privacy. It allows friends and relatives of homeowners—as well as small law firms and financial advisors—to offer trustee-like protection at low cost because it narrows the scope of service to real estate protection only and invokes other services, such as legal representation, only when they are needed.

To reiterate: The system and method of the present invention is not a trust because legal title is always held by the homeowner, not by a trust or trustee, and no one other than the homeowner ever has any control over the homeowner's property.

While the described system utilizes a blockchain ledger and process for recording transfers of ownership and encumbrances of assets, it should be understood that the present technology of the blockchain network can be public, private, permissioned or built by a consortium, and may utilize one or more forms of cryptography, encoding, proof of work challenges, or other concepts and technologies involved in available blockchain standards or suitable alternative databases/ledgers.

In various embodiments, the system and method contemplates included third-party information such as non-fungible tokens (NFTs) representing digital assets associated with the property, which will be described further below.

Referring back to FIGS. 1A-1B, in step 108, a prospective counterparty applies to the enforcement agent for a certificate of compliance for a transaction.

In step 110, the enforcement agent submits the transaction to the protective scheme.

In step 112, if the transaction fails to meet the requirements of the protective scheme, the enforcement agent declines to issue a certificate of compliance to allow the transaction to proceed.

In step 114, if the transaction passes, the enforcement agent creates a cryptographic hash of the key terms of the approved transaction agreement and other supporting information, including the hash of the recorded covenant or the enforcement agent's covenant signature.

In step 116, the enforcement agent signs the hash with its cryptographic signature using its private key in step 118.

In step 120, the enforcement agent issues a certificate of compliance that includes the cryptographically signed hash.

In step 122, the enforcement agent adds the certificate of compliance to the federated blockchain repository.

The homeowner and the counterparty execute the transaction agreement. In step 124, The counterparty records the transaction agreement along with the cryptographically signed certificate of compliance, and the method 100 continues to step 126 in FIG. 1B.

In step 126, the third party interested in verifying the certificate of compliance obtains it from the recorded transaction of step 134.

In step 128, the interested third party decrypts the digitally signed deal hash on the certificate of compliance using the enforcement agent's public key, in step 130, which can be found on the protective covenant and elsewhere.

In step 132, if the decryption is successful, the hash of the key terms of the transaction agreement that was approved is revealed.

In step 134, the counterparty, or any party, examines records the recorded transaction of step 124 for the deal terms which include the recorded protective covenant hash of step 104.

In step 136, the hash of the deal is received. In step 138, the third party compares the revealed hash to the hash of the terms and other inputs on the face of the recorded agreement that purports to convey to the counterparty the interest the third party seeks to acquire.

In step 140, if the decrypted hash on the certificate of compliance matches the hash of the terms and other inputs in the recorded agreement, then the transaction was certified by the enforcement agent and the counterparty possesses a legitimate interest.

In step 142, if the decrypted hash of the certificate does not match the hash of the terms and inputs in the recorded agreement then the certificate is not valid and the counterparty does not have a legitimate interest to convey.

If the counterparty is authorized to do so, in step 140, it may access the federated blockchain repository and use the enforcement agent's public key to decrypt the hashes of the pertinent documents and examine them.

FIG. 2 depicts an exemplary environment 202 of a system 200 for creating and/or maintaining a distributed ledger or blockchain registry according to the present teaching. Although FIG. 2 depicts certain entities, components, and devices, it should be appreciated that additional or alternate components are envisioned.

As illustrated in FIG. 2, the environment 202 may include a distributed ledger or blockchain registry 204. The distributed ledger or blockchain registry 204 may be maintained via a network of nodes, third-party remote servers or other computing devices, and/or an enforcement agent server 206. The nodes may have access to distributed ledger 204 and/or generate data included in the distributed ledger 204.

According to certain aspects, as described above, the input device may be an electronic device that includes a plurality of sensors, including biometric sensors. The input device may communicate with third-party remote servers, and/or the enforcement agent server 206. In some embodiments, the system can authenticate the identity of the user using a biometric authentication to provide an additional layer of security. In certain embodiments, the system can include a biometric authentication module (not shown) that includes a control and a biometric sensor. Biometric authentication can begin with the collection of a digital biometric sample (e.g., bitmap image of user's fingerprint) using the biometric sensor to confirm the user's identity.

As illustrated in FIG. 2, the enforcement agent server 206 may include a blockchain manager 208. The blockchain manager 208 may be a software program, engine, and/or a module that is executed by one or more processors interconnected with the enforcement agent server 206. In one embodiment, the blockchain manager 208 may compile a plurality of transactions into a block, update the distributed ledger 204 to include a block, route transaction data to one or more smart contracts, and/or automatically enforce one or more smart contracts associated with the real property.

According to certain aspects, an operator of the enforcement agent server 206 may interact with a management interface 212 to control aspects of the distributed ledger 204 and/or set control parameters associated with the blockchain manager 208. In one aspect, the plurality of smart contracts associated with the distributed ledger 204 and the real property may be stored in a smart contracts database 210. Although FIG. 2 depicts the smart contract database 210 as a part of the enforcement agent sever 206, the smart contract database 210 may be maintained within the distributed ledger 204.

According to certain aspects, one or more public devices 214 may access data stored at the enforcement agent server via a public interface 216, such as by using the real property identification information, such as the property address or legal description of the property, to access the data. The public interface 216 may be used, for example, to view data maintained within the distributed ledger 204 associated with the real property, to view the status of one or more smart contracts associated with the real property and/or the distributed ledger 204, compile statistics regarding data maintained in the distributed ledger, and so on.

Additionally, or alternatively, one or more third party applications 218 may interact with the distributed ledger 204 via an application program interface (API) 220 of the enforcement agent server 206. The third party applications 218 may be associated with one or more entities associated with real property. For example, the third-party applications 218 may include an application to generate various transactions identified by the real property, such as update title status, update ownership information, update lien and lienholder information, and so on. It should be appreciated that although FIG. 2 depicts the third-party applications 218 as separate from the enforcement agent sever 206, in some embodiments a portion of the third-party applications 218 may be stored locally at the enforcement agent server 206.

The exemplary environment 202 may include additional, fewer, or alternate equipment or components, including those discussed elsewhere herein. Further, in some embodiments, the actions described as being performed by the enforcement agent server 206 may additionally or alternatively be performed at one or more of the input devices, or third-party remote servers or computing devices.

As illustrated in FIG. 2, in accordance with some example embodiments, system 200 may include various means, such as one or more processors 222, memories 226, communications modules 228, and/or input/output modules 230. As referred to herein, the term “module” includes hardware, software and/or firmware configured to perform one or more particular functions. In this regard, system 200 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 226) that is executable by a suitably configured processing device (e.g., processor 222), or some combination thereof.

Processor 222 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. In an example embodiment, processor 222 is configured to execute instructions stored in memory 226 or otherwise accessible to processor 222. These instructions, when executed by processor 222, may cause system 200 to perform one or more of the functionalities of system 200 as described herein.

Memory 226 may comprise a single memory or may comprise a plurality of memory components. The plurality of memory components may be embodied on a single computing device or distributed across a plurality of computing devices. In various embodiments, memory 226 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. In some embodiments, memory 226 may comprise one or more databases. Memory 226 may be configured to store information, data, applications, instructions, or the like for enabling system 200 to carry out various functions in accordance with example embodiments of the present invention.

Communications module 228 may be embodied as any device or means embodied in circuitry, hardware, a computer program product comprising computer readable program instructions stored on a computer readable medium (e.g., memory 226) and executed by a processing device (e.g., processor 222), or a combination thereof that is configured to receive and/or transmit data from/to another device. In this regard, communications module 228 may be in communication with processor 222, such as via a bus. Communications module 228 may include, for example, an antenna, a transmitter, a receiver, a transceiver, network interface card and/or supporting hardware and/or firmware/software for enabling communications with another computing device.

Input/output module 230 may be in communication with processor 222 to receive an indication of a user input and/or to provide an audible, visual, mechanical, or other output to a user. As such, input/output module 230 may include support, for example, for a keyboard, a mouse, a joystick, a display, a touch screen display, a microphone, a speaker, a RFID reader, barcode reader, biometric scanner, and/or other input/output mechanisms.

In some embodiments, non-transitory computer readable storage media can be configured to store firmware, one or more application programs, and/or other software, which include instructions and other computer-readable program code portions that can be executed to control each processor (e.g., processor 222, engine and/or a module of the engine) of the system 200 to implement various operations. As such, a series of computer-readable program code portions are embodied in one or more computer program products and can be used, with a computing device, server, and/or other programmable apparatus, to produce machine-implemented processes.

In various embodiments, the system and method contemplates the present teaching in use with non-fungible tokens (NFTs). Some aspects of this invention are directed to digital asset ownership. The digital asset can be recorded as a non-fungible token (NFT) in a blockchain. The present invention adds protective schemes to the blockchain which prevent future transfer of the NFT when the protective scheme's requirements have not been met.

In various embodiments, the system and method contemplates extending third party information systems to include notice of the protective covenant. Sometimes, an unscrupulous party will check the land records when attempting to steal a person's home title or deed. According to an example of the present invention, the shared data from the protective covenant blockchain may be available to third parties, such as Zillow®. When a party conducts a search for the property on the land registry records or a property listing site, a digital representation of the real property, as the NFT, linked with the terms of the covenant may be displayed to the person searching the records to put them on notice of the restriction and/or requirements for an authenticated transfer of the real property.

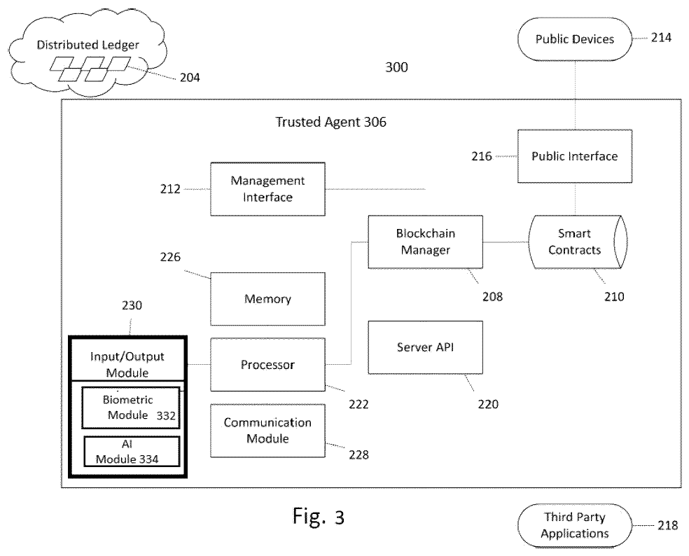

As shown in FIG. 3, various embodiments may provide a system 300 including a trusted agent 306 that not only confirms the identity of the person who is executing a property transfer, but also evaluates the person's condition (ensuring that the person is not under duress or impersonated) and analyzes vast data to detect any signs of fraud. In exemplary embodiments of the present disclosure, the trusted agent, for example, in a real estate transaction, may be configured as a system that uses multi-factor biometrics (e.g. facial recognition, fingerprints, voice) combined with AI-driven risk analysis to verify the property owner's identity and intent before authorizing a blockchain-recorded title transfer. The input/output module 230 may include, for example, a biometric module 332 and an artificial intelligence (AI) module 334.

In exemplary embodiments, the biometric analysis module 332 may include any suitable routines and/or algorithms configured to perform measurements of biological activities of a person. Examples of biometric algorithms of the biometric analysis module may include a respiration algorithm, a heart rate algorithm, a movement algorithm, a sound correlation algorithm, and others.

In exemplary embodiments, the AI module 334, also referred to as a machine learning or machine intelligence module may include a neural network (NN), e.g., a convolutional neural network (CNN), trained to determine whether a transaction (e.g., a property transaction) is fraudulent. Any suitable AI method and/or neural network may be implemented, e.g., using known techniques. For example, a fully convolutional neural network for image, facial and voice recognition may be implemented using the TensorFlow machine intelligence library.

According to the present teachings, use of the biometric analysis 332 may provide a mechanism to associate a transaction, such as a property transaction, to a person's unique physical or behavioral traits, ensuring the person approving a title transfer is indeed the authorized owner and is acting willingly. In addition, an AI system provides the ability to analyze complex patterns and large datasets in real-time—from transaction histories to legal records and news—to detect anomalies or events indicative of fraud.

By combining the biometrics identity verification and AI for fraud detection, the trusted agent system can, for example, automatically verify a property seller's identity via fingerprint and facial recognition, determine if the seller is under unusual stress (which may signal coercion or incapacity), and simultaneously conduct a background AI check to determine if the transaction or involved parties have a history of conducting known fraud schemes. Thus, one of the goals of the present disclosure is a seamless, secure process where legitimate transactions are easily implemented by the system, while suspicious transactions are detected early and subjected to additional scrutiny.

To facilitate biometrics for identity verification and a user state assessment, some embodiments provide a biometric system that is multi-faceted which can verify a person's identity and even detect indicators regarding the person's current physiological and mental state (for instance, calm or under duress, healthy or impaired). Exemplary embodiments may combine multiple biometric tests (e.g., face, fingerprint, and voice) to increase authentication accuracy and prevent spoofing attempts.

In addition to the biometric verification according to various embodiments, the system can detect subtle cues from a person's face, voice or handwriting that can be analyzed by AI to detect stress levels or cognitive state, adding an extra layer of protection against coerced or uninformed transactions.

In an embodiment, facial recognition can be employed through the use of deep learning algorithms that can match a live face to stored images, for example, a photograph provided on a government identification) with approximately 99% accuracy. Various embodiments of the facial recognition feature can also perform liveness detection to ensure the face is real and present (not a photo or video deepfake). The liveness detection can include analyzing micro-expressions, skin texture, and 3D depth via infrared sensors to distinguish a live person from an image or mask. For example, advanced presentation attack detection (PAD) can detect subtle signs (like an absence of natural eye micro-movements or abnormal lighting on a fake face) and thus block spoof attempts in real-time.

In addition to confirming identity, the facial analysis algorithm may be used to estimate a person's age. For example, in a property transaction, age detection can be implemented as a consistency check (e.g., flagging if the person's presented age does not match property records for the owner, possibly indicating identity fraud). In another embodiment, iris/retina scanning can be deployed for facial recognition. Iris recognition can be used for pattern-matching the unique iris texture of a person's eye.

In yet another embodiment, through the use of AI, health and stress indicators may be detected from a person's face: For example, slight changes in facial blood flow or micro-expressions can be detected to indicate stress or deception. In practice, according to the present disclosure, the system can detect indicators or signs like perspiration on the person's face, pupil dilation, trembling in facial muscles, or an overall expression that does not match the context (e.g., when someone appears unusually anxious during what should be a normal transaction). For instance, if a property owner is being coerced to sign documents, their face may show distress—the automated agent can detect the stress and trigger an alert or a double-confirmation step.

As described above, according to the present disclosure, fingerprints can be used for rapid and reliable identity verification. In use, the property owner's fingerprint, on file from an initial registration, must match the fingerprint at the time of transaction. In some embodiments, biometric scanners and smart devices can also be used to check for fingerprint liveness—for example, by detecting slight blood flow or skin elasticity—to ensure a real finger is being used and not a silicone fake. This feature is similar to facial liveness detection. Such measures can ensure the security of fingerprint authentication remains high, because, as secure as fingerprints are, they can be spoofed if someone lifts a print and makes a mold. In other embodiments, devices with ultrasound-based fingerprint sensors may be employed to detect the 3D details of ridges of a person's finger and even the pulse in the person's fingertip, adding confidence that the finger is attached to a live person.

In an embodiment, voice biometrics may be used for voice recognition wherein speaking serves as identification and emotion clues. By analyzing a person's voice print—the unique patterns in their speech (frequency, accent, timing, inflection), the system can authenticate a person's identity approximately in a few seconds of natural speech. For instance, a user might speak a passphrase, and the system may match the voice to a known profile.

The AI voice recognition of the system can account for background noise and even a degree of voice change (due to aging or illness). The system can detect imitators that try to impersonate the property owner's voice, subtle differences in the person's voice pattern can be detected. To counter the threat of AI-generated voices (deepfake audio), the system may use voice biometrics detection algorithms to detect anomalies or lack of natural variation in AI-synthesized speech.

In some embodiments, voice recognition may be used for detecting a person's emotional state. In addition to identification, a person's voice carries emotional information. When under stress or lying, many people exhibit measurable vocal changes: their pitch might go higher, they might speak faster or slower, or the voice may quiver slightly. According to the present disclosure, AI models can be used to perform voice stress analysis to detect these emotional cues. For instance, if the trusted agent system hears the property owner speaking (say, giving a verbal confirmation of the transaction) and detects a strained tone or trembling in their voice, the system may flag the interaction. For example, maybe the owner is under duress from a fraudster standing just outside camera view-their voice may reflect fear. The system can detect the fear emotion and require additional verification steps or alert an official to intervene.

In embodiments, speech analysis AI can also be used to detect conditions such as intoxication or cognitive impairment from voice patterns. Slurred or incoherent speech may indicate the person is not in a sound state of mind to make decisions. All these vocal indicators may supplement the identity verification with a physiological check.

In embodiments, handwriting, particularly signatures, may be used for verification. In a particular embodiment, machine learning can be used to analyze handwriting for patterns that correlate with personality or mental state.

In some embodiments, a person's handwriting can be analyzed to detect mental and physical conditions. For instance, the system may analyze handwriting features, such as the pressure exerted, the size and slant of text, consistency of letter shapes, spacing, etc., to detect changes with a person's mood, level of stress, age, or neurological condition. For instance, the system may use (e.g., convolutional neural network (CNN)) to detect a person's anxiety that may be indicated by shaky lines or inconsistent letter formation.

In an example of using the system, when the property owner signs a digital contract (likely using a stylus or finger on a touchscreen), the system can compare the signature to the signature previously obtained and on file for identity verification, and simultaneously evaluate features like stroke speed and pressure. If the analyzed signature is significantly different from the reference signature, the system may generate a notice for identity fraud (or perhaps the person's hand is shaking badly, which itself may signal a problem). If the signature matches but shows unusual tremor or pressure patterns, the system may generate a notice to indicate the signer is under stress or duress at that moment.

In embodiments, the system may implement various biometric inputs, such as face and iris scan, fingerprint scan, voice recognition, and handwriting verification, individually or in combination. In a multi-modal biometric mode, the system may use two or more biometric inputs together which can significantly boost security and accuracy of the system.

In a property transfer, one approach may include the following exemplary verification steps:
The owner logs into the transaction system by scanning their face and entering a password or PIN as a two-factor login process.
When ready to approve a title transfer, the system may be configured to require the owner to speak a confirmation phrase and provide a fingerprint on a reader. The system compares voice and fingerprint to the enrolled data (ensuring identity) and also monitors their face during the process for any signs of duress (e.g., another person coercing them might appear in the background, or their expression indicates fear).
The owner then signs the digital contract on screen. The signature may be biometrically verified and also archived as evidence.
All the biometric data points may be input into an algorithm that computes an identity and consent confidence score. If all the person's biometric data is verified (i.e., identity confirmed, no indicators of stress/duress), the system calculates a higher score for the transactions. However, if the system is unable to verify one or more of the biometric data, the system may calculate a lower score.

Accordingly, the use of a combination of biometrics can provide a highly reliable determination that the correct person is voluntarily executing the transaction and prevents impostors or undue influence from compromising the transaction.

In various embodiments, these biometric inputs can be fed into the trusted agent's decision logic to address the part of the fraud detection system that verifies the identification of the person. In other embodiments, AI can be used to scrutinize the what, where, and with whom aspects to detect potential fraud schemes.

Various embodiments of the present disclosure may use AI fraud detection. The system may employ AI models for fraud detection using a variety of approaches, such as machine learning on big data, natural language processing of documents, and network analytics mapping relationships. The system may use AI to assess whether a given property transaction is likely legitimate or if it bears warning signs of fraud.

In an embodiment, the system may utilize a machine learning (ML) model trained on historical data of both fraudulent and legitimate transactions such that the algorithms can learn patterns that correlate with fraud. These patterns can indicate combinations of factors like transaction amount, how quickly a property was transferred or flipped, and whether the seller had recently acquired the property under unusual circumstances, etc.

In a particular embodiment, the ML model may be configured to learn that fraudulent real estate transactions often have certain traits, such as, the property was quit-claimed a few months prior (a possible attempt to muddy title ownership), or the sale is happening below market value between related parties, or the seller's contact information appears inconsistent. Once trained, the model can examine a new transaction and output a risk score or a binary prediction (fraud/not fraud).

In other embodiment, the system can employ AI for anomaly detection. This can involve establishing a baseline of a normal transaction behavior and spotting outliers. For example, if typically a certain neighborhood's titles only change owners after proper notarization and several years of ownership, but then there is a sudden title transferred twice in two weeks to different LLCs, the system may note this transaction as an anomaly. The AI system can monitor such out-of-pattern events continuously.

In yet another embodiment, the system can use graph analytics to detect fraudulent transactions. Fraudsters often operate in networks (e.g., a ring of colluding individuals and shell companies). According to the present disclose, AI can map relationships between entities—who is connected to whom—by mining data like names, addresses, notaries, banks used, etc. If the same notary public shows up in multiple suspicious transactions, or the buyer of this property is associated (through corporate records) with another person who was involved in a past fraudulent case, the system using a graph-based AI can detect these connections. In real estate, graph analytics can detect, for example, a fraudulent deed ring where a corrupt title agent has quietly facilitated several fraudulent transfers.

In some embodiments, predictive analytics can be utilized to anticipate risk. For example, using regression models or classification, through the use of AI, the system can predict the likelihood of fraud for a transaction before any issue occurs. If certain combinations of factors (location, asset value, buyer/seller profiles, etc.) statistically led to fraud in the past, the model can assign a higher risk score to new transactions with similar profiles, which can require additional checks on the transactions.

In such embodiments, the AI of the system can be trained on data such as:
Property and transaction details: prices, dates, property type, loan info, etc.
Party details: buyer/seller age, prior transactions, ownership history.
Known fraud cases: flagged by authorities or insurance claims.
Geospatial data: some areas may indicate higher fraud incidence.
Temporal patterns: e.g., a high occurrence in certain transaction types at the end of year may indicate suspicious or fraudulent transactions.

In various embodiments, the system can deploy Natural Language Processing (NLP) to process a huge amount of information in real estate transactions that include, for example, unstructured text, such as deeds, titles, liens, contracts, emails, etc. The system can use document NLP analysis to understand and analyze human language, for example, in contracts, deeds, identifications, and communications. In fraud detection, the system can use NLP to scrutinize text for inconsistencies, suspicious language, or clues of tampering. The system can use NLP to detect inconsistencies or suspicious content, forged documents, altered records, or unusual contract clauses not typically included in standard deals.

In one application, the system can use NLP-driven document comparison so that AI extracts structured data from documents and then automatically flags any mismatch. For instance, the property description in the sale contract says “Lot 41, Block 6” but the title record fetched lists “Lot 14, Block 6”—a detail a human may overlook but the system's AI can detect such discrepancy.

Another application by the system can include using NLP to identify fraudulent language or unusual clauses. Real estate contracts typically include standard terms. If a contract includes odd provisions (for example, assigning power of attorney to someone in an unusual manner, or a clause that the seller remains on title in some capacity), the AI can flag it as out-of-the-ordinary for additional review. The NLP can also detect transactions where scammers can sometimes embed clauses that allow them to undo a transaction or retain some control, hoping that the unusual clause is unnoticed. The system's NLP can detect the unusual clause, because it can be trained on thousands of “normal” contracts such that it can detect usual clauses.

A further application is that NLP can be used for public records text mining. In embodiments, the system can employ NLP to search through court records or news articles for relevant content about the people or property. In such embodiments, NLP can add an ability to “read and comprehend” the textual content around a transaction. With the use of NLP, the system can perform proofreading and investigation to detect forged or inconsistent documents and locate any textual evidence of wrongdoing. In an embodiment, the NLP algorithms can detect forged signatures or mismatched property details in documents automatically, which are tasks that would otherwise require expert scrutiny.

Another advantage of the system is the use of AI to analyze vast amount of diverse data. By employing NLP to mine public records, the system can detect external fraud indicators, such as a party in a lawsuit or bankruptcy, a property under lien or foreclosure, or a recently formed shell company. Through AI the system can not only retrieve data regarding the property transaction, but can also collect external information from, for example, a property records database, business registries (Secretary of State records), and court records. The trusted agent of the system can leverage NLP to perform adverse media screening by analyzing data in news articles, watchlists, and sanction lists to detect individuals or companies reported as involved in fraud or crime as bad actors. The trusted agent of the system can also use NLP to search social media and online data for clues to detect fraudulent transactions or fraudsters. For example, the seller's social media may indicate information contradicting the transactions (e.g., a Zillow posting that states “My house is not for sale”).

By combining all these data sources, using AI, the system can build a comprehensive, automated due diligence analysis and report on the transaction and participants in real-time or near-real-time. The AI-powered system can monitor the transactions in real-time and detect issues before the property title is irrevocably transferred.

For example, while the transaction is being conducted the main details of the transaction (identities, property ID, etc.) can be input into the system, the AI of the system can immediately begin analyzing the transaction:
Immediately score the risk of the transaction and the parties.
If the risk crosses a threshold, the system can activate a hold that suspends automated approval of the transaction.
The system can also notify relevant parties (e.g., contact the owner through a phone call, text, or email to double-confirm they initiated the transaction).

With real-time monitoring, the system can also use AI to continuously monitor for any changes or new data until the transaction is finalized. For instance, if during the closing process a new lien is filed on the property (which in some scams, fraudsters might quickly attempt), the system can detect that by querying the public records once more and raise an alarm.

According to embodiments, the AI of the system can provide instant alerts on suspicious activities, effectively preventing fraud from going through undetected. The responsiveness of the system's AI can detect fraud at the “point of capture” of the data of the transaction into the system (the moment it is being attempted) rather than after the damage is done.

In various embodiments, the system can determine a fraud likelihood score for each transaction. In embodiments, the AI analysis can be converted into a score or decision. For example, after all analyses, the system can assign the transaction a score of 85 out of 100 on the risk scale. The system can have predefined rules, for example:
0-50: Low risk, likely a legitimate transaction. Automatically-approve (assuming biometrics are also verified).
50-80: Medium risk. The system can transfer the transaction to a human underwriter or require some additional proof (such as providing a verification query to the seller asking a few knowledge-based questions).
80-100: High risk. The system automatically suspends the transaction and initiates a thorough investigation by authorities.

The Trusted Agent can use the fraud likelihood score in conjunction with the biometric results. In an example transaction where the biometrics are verified but the AI analysis indicates a high fraud likelihood score:
Biometrics indicates: identity 95% verified, person calm and healthy.
AI risk score indicates: 90/100 risk, because the system detects that the buyer is paying with an overseas fund and the property was involved in an unusual title change last month.

In this example transaction, the system can issue an alert of “heightened scrutiny”. The system can suspend the transaction and require a human escrow agent to review the transaction details before any approval.

In another example transaction, where the biometrics are not verified and the AI analysis indicates a low risk of fraud likelihood score:
If biometrics were not confirmed (e.g., the person's face did not match perfectly or the person seemed under stress), but AI risk on the deal is low (nothing suspicious indicators detected in the background check), the system still can suspend or escalate the transaction.

Thus, in the embodiments of the present disclosure, the AI's output complements the biometric identity verification. Together, they ensure that both the user and the transaction are vetted:

Biometrics verifies: “Is this the true owner and are they willingly participating?”

AI verifies: “Is this transaction itself likely legitimate or part of a fraud scheme?”

In various embodiments, the biometrics and AI can be implemented to operate together in a unified trusted agent 306 workflow for secure property transactions. In such embodiments, at every main step of a transaction, the system can either verify identity/consent of the person through biometrics or verify context/legitimacy of the transaction through AI checks. Thus, the system can be configured in some embodiments to only allow the transaction to proceed if all checks are satisfactorily passed.

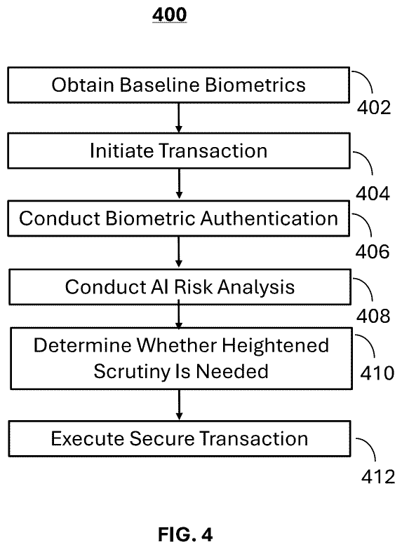

FIG. 4 is an example of a process 400 performed or otherwise implemented by a unified trusted agent 306 that implements the biometrics and AI concurrently to verify identity/consent of the person through biometrics or verify context/legitimacy of the transaction through AI authentication.

At step 402, the system 300 may activate the trusted agent 306 to perform a baseline enrollment. As a prerequisite, the property owner may enroll their biometrics with the system 306 in advance of conducting a transaction. For example, when signing up for the service, the system 300 may prompt the owner to provide a face scan, fingerprint, voice sample, and a signature. These biometrics may be registered into the system to become the baseline records for future comparison. Additionally, the system may request that the owner's identity documents (ID, title deed, etc.) are validated and associated in the system with the owner's biometrics.

At step 404, the system 300 may use the trusted agent 306 to initiate the transaction. For example, when the owner (seller) logs into the digital platform to initiate a property title transfer, such as a sale or adding someone to the title, the system 300 may first require a login that uses biometrics (e.g., face login or fingerprint on their device). Upon starting the transaction, the system 300 may collect data regarding the transaction: property ID, buyer's information, sale terms, etc., The system 300 may begin the fraud analysis.

At step 406, the system 300 may conduct biometric authentication for approval of the transaction. During the signing of the transaction by the owner, the trusted agent 306 may engage the multi-factor biometrics of the biometric module 332. The system 300 may prompt the owner to confirm their identity and consent, for example, by conducting:
Face & Liveness Check: The system 300 may instruct the owner to look into their device's camera. The system 300 may compare the live face to the stored profile and runs liveness detection (asking the owner to blink or turn their head).
Voice Confirmation: The system 300 may instruct the owner to speak a phrase like “I authorize this property transfer on [date]”. The system may compare the voice and also analyze stress in their tone.
Fingerprint Scan: The system 300 may instruct the owner to press their finger on a reader (or uses their phone's fingerprint sensor) to verify the owner's fingerprint identity.
Digital Signature: The system 300 may instruct the owner to sign the electronic document (on-screen). The system may compare the signature to the baseline and check for any anomalies (like a very shaky signature).

During step 406, the system 300 essentially determines: “Is this truly the same person who owns the title, and are they signing willingly?” If any of these checks fail (e.g., face does not match, or the owner cannot provide the correct biometric), the process may be suspended at this step in the process. The trusted agent 306 may not proceed to approve a potentially unauthorized transaction. When the biometrics authenticate the user, the system 300 proceeds.

At step 408, the system 300 may conduct AI risk analysis for approval of the transaction. While the system 300 is vetting the owner through biometric authentication using the biometric module 332, the AI module 334 may currently perform due diligence on the transaction by conducting, for example, the following:
It queries databases for property history: detects past sales, checks whether there were recent odd changes (e.g., an unusual transfer or lien).
It collects buyer's profile: If the buyer is an individual, the system 300 may conduct an identity verification to determine whether the name appears in sanction lists or fraud reports. If the buyer is a company, it checks the registration date and owners of that company.
It scans public records: Searches court cases for the parties' names (maybe there are two owners listed on a deed, meaning one owner cannot sell without the other owner's consent, etc.), and looks at local property records for any concurrent filings.
It performs adverse media search: using NLP to find any news articles or public warnings about the buyer, seller, or even the address (perhaps the address is known in a foreclosure scam).
It evaluates the transaction parameters: price versus market, payment method (cash versus financing), any rush in timing-inputting this information into the ML model to calculate fraud probability.

The system 300 may perform the AI risk analysis very quickly (e.g., in 5-30 seconds). By the completion of the owner's biometric confirmation, the AI module 334 can determine and prepare a risk score.

At step 410, the system 300 may make a decision to perform a heightened scrutiny, when needed. The system 300 may synthesize the biometric results and the AI risk analysis:
If system 300 confirms the identities of the parties and the AI's fraud risk score is low, the trusted agent 306 may approve the transaction. The system 300 may approve the smart contract or transaction for execution.
If either the identities of the parties are not confirmed or fraud risk is high, the system 300 may generate a heightened scrutiny alert. For example, the system may:
   (a) Require additional authentication (e.g., a one-time passcode sent via a different channel to authenticate the owner or involvement of a human notary to physically verify identity if possible).
   (b) Assigning the transaction for manual review by a fraud officer or legal authority.
   (c) Potentially alerting the owner via a known safe contact method. For example, the system 300 may send a notice stating, “We detected unusual activity in your property transaction-if you did not intend this, please alert authorities.” This is an example to detect cases where potentially the owner was deepfaked or coerced and may later confirm the transaction was fraudulent.

At step 412, the system 300 may execute a secure transaction. If the transaction is approved through biometric and AI authentication, the system 300 may execute the transaction. In a blockchain-based system, the system 300 may:
Record the transfer of title on the blockchain ledger, embedding relevant details (such as a reference to the biometric authentication event, a cryptographic signature provided by the trusted agent 306, etc.).
Store an auditable log of all checks performed—biometrics used, risk score, data sources consulted—as proof that due diligence was performed. Thus, the system 300 may create a digital trail that may be used as confirmation if the transaction is later questioned.

In alternate embodiment, if the platform is not blockchain but a traditional database, the system may perform similar update in the registry, along with cryptographic logging of the verification steps for security.

At this point, in the process 400 in this example, the system has transferred the property title through a transaction with trust and verification built in. All parties (and possibly regulators) can be confident that the transfer was legitimate: the rightful owner consented and no known fraud indicators were detected. By the system 300, the “certificate of approval” for the transaction—effectively, the Trusted Agent's signature—is generated and attached to the title record.

In summary, the integration of the biometrics and AI may operate together as a series of verifications: the biometric verification must be authenticated (verifying the person), and the AI risk verification must also be authenticated (verifying the transaction). Only after both verifications are confirmed may the system complete the transaction. This dramatically reduces the risk of fraudulent property transfers, compared to a scenario where someone attempts to forge documents or impersonate an owner to conduct a fake transaction.

It is contemplated that, in some embodiments, the system 300 may be implemented to protect vulnerable individuals (e.g., elderly, non-English speakers, etc.). The system of the present disclosure may be deployed as a tool functioning as a fully autonomous, biometric-and-AI driven property transfer agent. The system 300 as a tool, for example, may be used to detect unusual stress or require extra checks when an elderly owner transfers a home. The system 300 can be used to add a safeguard for people who may be signing under duress or confusion (elderly, non-English speakers, etc.). By detecting abnormal stress or patterns, the system can detect and stop unscrupulous individuals (e.g., a dishonest relative or caregiver coercing an elderly person) from fraudulently transferring the property. Thus, the system 300 may serve as a built-in advocate that issues alerts when a suspicious transaction is detected.

It is contemplated that, in some embodiments, a fully autonomous, biometric-and-AI driven property transfer agent refers to a system that can facilitate real estate transactions end-to-end with minimal human intervention. Such an embodiment leverages the biometric identity verification, artificial intelligence (AI), and blockchain smart contracts to handle everything from verifying the parties to transferring the title on a secure digital ledger.

In an exemplary embodiment of a fully autonomous transfer implemented by a fully autonomous, biometric-and-AI driven property transfer agent may include the following steps:

An Initiation & Identity Step: The seller may initiate a sale through an online platform (or AI assistant) and confirm their identity biometrically (for example, a fingerprint via a mobile ID app). The system may collect the property details (deed, token ID, etc.) from the blockchain-based registry. The buyer similarly logs into the system with biometrics and signals an intent to buy. At this stage, both parties' credentials are cryptographically verified—the system confirms with high certainty the identities of the parties since there is no human agent verifying the identification.

Smart Contract Setup Step: An AI-driven module may generate a draft sale agreement. The AI-driven module may use a smart contract template approved by authorities. The AI may fill in the parties' names, property token ID, price, and any conditions (e.g. subject to inspection or loan approval) into the template. The system may enable a buyer's AI assistant to negotiate small terms of the agreement (e.g., negotiation within parameters set by the humans). Once there is an agreement, the system may finalize the contract digitally. Both buyer and seller may sign the smart contract with their digital signatures (using their biometric IDs). Now the system has provided the instructions for the transfer to be implemented on the blockchain. However, the system will execute the transfer only when the conditions are satisfied.

Payment & Compliance Check Step: The system may request that the buyer initiate payment. For example, the buyer's bank may send a message that funds have been locked or a central bank digital currency (CBDC) token representing the money is placed in escrow. At the same time, the system's AI compliance agent automatically cross-references the transaction against anti-money laundering (AML) rules: it may query government databases to ensure neither party is on a sanctions list, verify the source of funds if required, and confirm that the property is not flagged (e.g., not under litigation or frozen by a court). The system may perform these verifications within seconds to minutes, due to the system's ability of the AI to parse data swiftly. If the system detects any suspicious activity, the system can suspend the transaction and alert a human officer. For example, if the buyer's credit check fails, the AI can notify them with reasons and potentially offer solutions (e.g., maybe suggest a smaller loan or adding a co-signer)-suggests steps that are similar to what a human mortgage agent would do. In an autonomous setup, an AI advisor bot may converse with the user to resolve issues, or transfer the issue to a human when it cannot be handled by the system's AI. Otherwise, if all checks are verified, the system may proceed with the transfer.

Automated Transfer Execution Step: The system may now execute the smart contract: it may trigger the payment transfer (e.g., transferring the locked funds to the seller's account) and simultaneously may transfer the property token on the blockchain from seller to buyer. Because the contract is on a blockchain, this is recorded immutably and transparently for all involved. The time stamp, price, and parties are all logged. In one embodiment, this step may be essentially instantaneous once triggered-no scheduling of closings or waiting for wire transfers overnight. In an alternative embodiment, AI may use predictive analytics to choose an optimal transfer time.

Post-Transfer Updates Step: The final step may include updating all relevant records autonomously. The blockchain's change of ownership may be the recorded so that the land registry's database is updated automatically. The new owner may receive a digital title (e.g., as a PDF or a token in their digital wallet). City tax authorities may also be notified automatically (triggering pro-rated property tax bills). If the transaction involves a mortgage, the system may register the smart contract with the lender's lien on the property, and the bank's systems may reflect the new loan.

With the use of the fully autonomous, biometric-and-AI driven property transfer agent as described in the present disclosure, every action taken during the transaction is logged and transparent, which builds trust. Participants and regulators may later audit the blockchain record to review the details of exactly what happened and when, reducing the possibility of fraud.

Aspects of this disclosure may be implemented, in some embodiments, through a computer-executable program of instructions, such as program modules, generally referred to as software applications or application programs executed by any of a controller or the controller variations described herein. Software may include, in non-limiting examples, routines, programs, objects, components, and data structures that perform particular tasks or implement particular data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by resident and remote-processing devices that are linked through a communications network. In a distributed-computing environment, program modules may be located in both local and remote computer-storage media including memory storage devices. Aspects of the present disclosure may therefore be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, control logic, protocol or method disclosed herein may be embodied as software stored on a tangible medium such as, for example, a flash memory, a CD-ROM, a floppy disk, a hard drive, a digital versatile disk (DVD), or other memory devices. The entire algorithm, control logic, protocol, or method, and/or parts thereof, may alternatively be executed by a device other than a controller and/or embodied in firmware or dedicated hardware in an available manner (e.g., implemented by an application specific integrated circuit (ASIC), a programmable logic device (PLD), a field programmable logic device (FPLD), discrete logic, etc.). Further, although specific algorithms are described with reference to flowcharts depicted herein, many other methods for implementing the example machine-readable instructions may alternatively be used.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and sub-combinations of the preceding elements and features.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments described herein can be embodied within a form that does not provide all of the features and benefits set forth herein, as some features can be used or practiced separately from others. All changes that come within the meaning and range of equivalency of the claims are to be embraced within their scope.

What is claimed is:

1. A computer-implemented method for implementing an autonomous, biometric and artificial intelligent transfer agent to verify consent to a transfer of title to a property, the method comprising:
receiving, by an enforcement agent computing system, a digital request to initiate a property title transfer from a current property owner;
dynamically monitoring, by the enforcement agent computing system, transaction data related to the property for an event indicating a pending title transfer subject by a predefined protective scheme;
authenticating an identity of the current property owner using multiple biometric factors, and comparing each biometric factor to stored reference biometric data, to generate an identity verification result;
analyzing contextual information associated with the title transfer using an artificial intelligence risk model to detect any anomaly or risk factor indicative of fraud, incapacity, or undue influence, thereby producing a compliance risk assessment result;
upon determining that the identity verification result confirms the property owner's identity and that the compliance risk assessment result indicates no disqualifying risk, generating, by the enforcement agent computing system, a digital certificate of compliance attesting that the pending title transfer meets all protective scheme conditions, wherein generating the digital certificate comprises computing a cryptographic digest of key terms of the title transfer and digitally signing the digest with a private cryptographic key of the enforcement agent; and
recording, in a blockchain distributed ledger that maintains property title records, the digitally signed certificate of compliance in association with the property's title, thereby authorizing completion of the property title transfer, wherein absence of the digitally signed certificate of compliance in the distributed ledger causes the title transfer to be deemed invalid under the protective scheme.

2. The method of claim 1, wherein authenticating the identity of the current property owner comprises capturing a live facial image and a fingerprint and confirming that both the facial image and fingerprint match previously enrolled biometric credentials of the property owner on record.

3. The method of claim 1, wherein authenticating the identity of the current property owner further comprises capturing an audio sample of the property owner's voice speaking a predetermined phrase and comparing the audio sample to a stored voice profile to verify the property owner's identity, and analyzing the audio sample for vocal stress patterns to ensure the property owner is not under duress during the title transfer.

4. The method of claim 1, further comprising, prior to generating the digital certificate of compliance, determining that the property owner meets one or more vulnerability criteria selected from: exceeding a certain age threshold, recently losing a spouse or co-owner, or lacking another signatory on the transfer; and in response, automatically alerting a pre-designated trusted contact of the property owner or requiring participation of a legal representative for the property owner as an additional safeguard before proceeding with the title transfer.

5. The method of claim 1, wherein analyzing contextual information using the artificial intelligence risk model includes cross-referencing external data sources for irregularities by: retrieving public records and transaction history for the property and parties associated with the title transfer, checking for any active liens, legal incapacitation notices, or recent rapid title changes for the property, and identifying any deviation in the pending transfer's terms or timing from an expected baseline, and wherein the method further comprises refraining from generating the certificate of compliance and outputting a warning if the artificial intelligence risk model detects a risk factor above a predefined threshold.

6. The method of claim 1, wherein generating the digital certificate of compliance comprises computing a cryptographic hash of a transfer agreement executed by the property owner and a counterparty, and encrypting the hash with the enforcement agent's private cryptographic key to produce a digital signature that forms part of the certificate of compliance, such that, in a subsequent transaction, decrypting the signature with a corresponding public key of the enforcement agent authenticates the certificate of compliance.

7. The method of claim 1, wherein recording the digitally signed certificate of compliance in the blockchain distributed ledger comprises adding a new transaction record on a blockchain network that stores property title data, the new transaction record incorporating the certificate of compliance and linking the new transaction record to a previously recorded protective covenant associated with the property, the protective covenant having been recorded on the blockchain and including a public key of the enforcement agent and terms of the protective scheme.

8. The method of claim 1, wherein the requirement of the digitally signed certificate of compliance provides constructive notice to any subsequent purchaser or lender that a valid transfer of the property requires verified owner consent, thereby preventing any party from acquiring an interest in the property as a bona fide purchaser or holder in due course without the certificate of compliance and deterring fraudulent attempts to launder title through third parties.

9. The method of claim 1, wherein once the digitally signed certificate of compliance is recorded for a given property title transfer, the certificate of compliance provides conclusive evidence of the property owner's informed consent such that the property owner is estopped from subsequently challenging the transfer on grounds of alleged fraud in the inducement or lack of capacity, thereby ensuring marketability and reliability of title for a transferee and subsequent interest holders.

10. A system for implementing an autonomous, biometric and artificial intelligent transfer agent to verify consent to a transfer of title to a property, the system comprising:
one or more biometric sensors configured to capture multi-modal biometric data of a property owner;
a network interface configured to communicate with a blockchain distributed ledger that stores property title records; and
a processing unit operatively coupled to the biometric sensors and the network interface, the processing unit being configured to execute an enforcement agent program that:
(a) stores a protective ownership rule on the blockchain distributed ledger in association with a property's title, the rule including a public cryptographic key of an enforcement agent and requiring that any title transfer for the property be authorized by a digital certificate signed with a corresponding private key;
(b) responsive to receiving a request for a title transfer, captures live biometric samples of the property owner via the one or more biometric sensors and compares the biometric samples to reference biometric data to authenticate the property owner's identity;
(c) analyzes transaction context data for the requested transfer using an artificial intelligence risk model to detect any anomaly or risk factor indicating potential fraud;
(d) upon confirming the property owner's identity and absence of the risk factor, generates a digital certificate of compliance by cryptographically signing transaction-specific information with the private cryptographic key of the enforcement agent; and
(e) stores the digital certificate of compliance as a transaction to the blockchain distributed ledger via the network interface, thereby updating the property's title record to indicate an approved transfer of ownership.

11. The system of claim 10, wherein the one or more biometric sensors include at least a camera for capturing facial images, a fingerprint scanner, and a microphone for capturing the property owner's voice, and the enforcement agent program is further configured to perform liveness detection by prompting the property owner to perform an action detectable by the camera for facial movement or the microphone for voice response and verifying that an expected live response is present, thereby ensuring that the property owner is physically present and not a fake impersonation during the title transfer process.

12. The system of claim 10, wherein the enforcement agent program maintains, on the blockchain distributed ledger, a recorded protective covenant associated with the property's title, the protective covenant including the public cryptographic key of the enforcement agent and stipulating conditions of the protective ownership rule, and wherein the enforcement agent program, when posting the digital certificate of compliance, includes a reference to the protective covenant such that nodes of the blockchain distributed ledger validate the certificate of compliance against the protective covenant's public key and conditions before confirming the ownership transfer.

13. The system of claim 10, further comprising a secure user device in possession of the property owner and configured to store a private cryptographic key of the property owner, the secure user device including a biometric authentication mechanism that releases the property owner's private key only upon verifying the property owner's fingerprint or other biometric, wherein the processing unit is further configured to require a digital signature from the property owner's private key on the title transfer request in addition to the enforcement agent's digital certificate of compliance, such that independent cryptographic signatures are required from the property owner and from the enforcement agent to finalize the property title transfer.

14. A non-transitory computer readable medium configured to store instructions for implementing to cause a processor to perform operations comprising:
receiving, by an enforcement agent computing system, a digital request to initiate a property title transfer from a current property owner;
dynamically monitoring, by the enforcement agent computing system, transaction data related to the property for an event indicating a pending title transfer subject by a predefined protective scheme;
authenticating an identity of the current property owner using multiple biometric factors, and comparing each biometric factor to stored reference biometric data, to generate an identity verification result;
analyzing contextual information associated with the title transfer using an artificial intelligence risk model to detect any anomaly or risk factor indicative of fraud, incapacity, or undue influence, thereby producing a compliance risk assessment result;
upon determining that the identity verification result confirms the property owner's identity and that the compliance risk assessment result indicates no disqualifying risk, generating, by the enforcement agent computing system, a digital certificate of compliance attesting that the pending title transfer meets all protective scheme conditions, wherein generating the digital certificate comprises computing a cryptographic digest of key terms of the title transfer and digitally signing the digest with a private cryptographic key of the enforcement agent; and
recording, in a blockchain distributed ledger that maintains property title records, the digitally signed certificate of compliance in association with the property's title, thereby authorizing completion of the property title transfer, wherein absence of the digitally signed certificate of compliance in the distributed ledger causes the title transfer to be deemed invalid under the protective scheme.

15. The non-transitory computer readable medium according to claim 14, wherein authenticating the identity of the current property owner comprises capturing a live facial image and a fingerprint and confirming that both the facial image and fingerprint match previously enrolled biometric credentials of the property owner on record.

16. The non-transitory computer readable medium according to claim 14, wherein authenticating the identity of the current property owner further comprises capturing an audio sample of the property owner's voice speaking a predetermined phrase and comparing the audio sample to a stored voice profile to verify the property owner's identity, and analyzing the audio sample for vocal stress patterns to ensure the property owner is not under duress during the title transfer.

17. The non-transitory computer readable medium according to claim 14, further comprising, prior to generating the digital certificate of compliance, determining that the property owner meets one or more vulnerability criteria selected from: exceeding a certain age threshold, recently losing a spouse or co-owner, or lacking another signatory on the transfer; and in response, automatically alerting a pre-designated trusted contact of the property owner or requiring participation of a legal representative for the property owner as an additional safeguard before proceeding with the title transfer.

18. The non-transitory computer readable medium according to claim 14, wherein analyzing contextual information using the artificial intelligence risk model includes cross-referencing external data sources for irregularities by: retrieving public records and transaction history for the property and parties associated with the title transfer, checking for any active liens, legal incapacitation notices, or recent rapid title changes for the property, and identifying any deviation in the pending transfer's terms or timing from an expected baseline, and wherein the method further comprises refraining from generating the certificate of compliance and outputting a warning if the artificial intelligence risk model detects a risk factor above a predefined threshold.

19. The non-transitory computer readable medium according to claim 14, wherein generating the digital certificate of compliance comprises computing a cryptographic hash of a transfer agreement executed by the property owner and a counterparty, and encrypting the hash with the enforcement agent's private cryptographic key to produce a digital signature that forms part of the certificate of compliance, such that, in a subsequent transaction, decrypting the signature with a corresponding public key of the enforcement agent authenticates the certificate of compliance.

20. The non-transitory computer readable medium according to claim 14, wherein recording the digitally signed certificate of compliance in the blockchain distributed ledger comprises adding a new transaction record on a blockchain network that stores property title data, the new transaction record incorporating the certificate of compliance and linking the new transaction record to a previously recorded protective covenant associated with the property, the protective covenant having been recorded on the blockchain and including a public key of the enforcement agent and terms of the protective scheme.
